(19) United States
(12) Patent Application Publication
(10) Pub. No.: US 2026/0149912 A1
(43) Pub. Date: May 28, 2026

(54) EAR-WEARABLE ELECTRONIC DEVICE INCLUDING DEBRIS TRAP

(71) Applicant: Starkey Laboratories, Inc., Eden Prairie, MN (US)

(72) Inventors: Ganesh Borra, Minneapolis, MN (US); Mark Pankratz, Bloomington, MN (US); Eitan Cher, Denver, CO (US)

(21) Appl. No.: 19/396,895

(22) Filed: Nov. 21, 2025

Related U.S. Application Data
(60) Provisional application No. 63/725,600, filed on Nov. 27, 2024.
(60) Provisional application No. 63/725,602, filed on Nov. 27, 2024.

(51) Int. Cl. H04R 1/10; H04R 1/04

(52) U.S. Cl. CPC H04R 1/1075; H04R 1/04; H04R 1/1016

(57) ABSTRACT

Various embodiments of an ear-wearable electronic device are disclosed. The device includes an enclosure having a first housing and a second housing. The device also includes an acoustic path that extends along an axis between a first opening defined by an outer surface of the enclosure and a second opening defined by a surface of a cavity of a microphone coupler disposed within the enclosure. The acoustic path includes a first trap connected to the acoustic path adjacent the first opening of the acoustic path, and a second trap connected to the acoustic path so that the second trap is disposed closer to the second opening than the first trap. Each of the first trap and the second trap is configured to collect debris.

This application claims the benefit of U.S. Provisional Application No. 63/725,602, filed November 27, 2024, and U.S. Provisional Application No. 63/725,600, filed November 27, 2024, the disclosures of which are incorporated by reference herein in their entireties.

### SUMMARY

In general, the present disclosure provides various embodiments of an ear-wearable electronic device that includes an acoustic path that extends between a first opening defined by an outer surface of an enclosure of the device and a second opening disposed within the enclosure. The second opening can be defined by a cavity of a microphone coupler disposed within the enclosure. The device can also include one or more traps connected to the acoustic path that are configured to collect debris such as ear wax that can enter the acoustic path from an external environment of the enclosure. In one or more embodiments, the one or more traps can be integral with the acoustic path.

In one aspect, the present disclosure provides an ear-wearable electronic device that includes an enclosure having a first housing and a second housing. The device also includes an acoustic path that extends along an axis between a first opening defined by an outer surface of the enclosure and a second opening defined by a surface of a cavity of a microphone coupler disposed within the enclosure. The acoustic path includes a first trap connected to the acoustic path adjacent the first opening of the acoustic path, and a second trap connected to the acoustic path so that the second trap is disposed closer to the second opening than the first trap. Each of the first trap and the second trap is configured to collect debris.

In another aspect, the present disclosure provides an ear-wearable electronic device that includes an enclosure having a first housing, a second housing, and a spout extending from the second housing; and an electromechanical package. The electromechanical package includes a flexible printed circuit board assembly (PCBA) disposed within the enclosure, and a microphone disposed on or at least partially in the PCBA and including a microphone inlet. The ear-wearable electronic device further includes an acoustic path that extends along an axis between a first opening defined by an outer surface of the enclosure and a second opening defined by a surface of a cavity of a microphone coupler disposed within the enclosure, where the microphone inlet is

acoustically coupled to the acoustic path via the second opening when the microphone is disposed at least partially within the cavity of the microphone coupler. The ear-wearable device further includes a trap connected to the acoustic path adjacent the first opening of the acoustic path, where the trap is configured to collect debris. A distance from the first opening of the acoustic path to an antitragus of an ear of a wearer is less than a distance from the microphone inlet to the antitragus when the second housing of the ear-wearable electronic device is in contact with a concha of the ear of the wearer and the spout is disposed at least partially within an ear canal of the wearer.

In another aspect, the present disclosure provides a method of forming an ear-wearable electronic device. The method includes connecting a first housing to a second housing to form an enclosure; disposing an acoustic path at least partially within the enclosure, where the acoustic path extends along an axis between a first opening defined by an outer surface of the enclosure and a second opening defined by a surface of a cavity of a microphone coupler disposed within the enclosure; and connecting a first trap to a first portion of the acoustic path adjacent the first opening of the acoustic path. The method further includes connecting a second trap to a second portion of the acoustic path.

All headings provided herein are for the convenience of the reader and should not be used to limit the meaning of any text that follows the heading, unless so specified.

The terms “comprises” and variations thereof do not have a limiting meaning where these terms appear in the description and claims. Such terms will be understood to imply the inclusion of a stated step or element or group of steps or elements but not the exclusion of any other step or element or group of steps or elements.

The words “preferred” and “preferably” refer to embodiments of the disclosure that may afford certain benefits, under certain circumstances; however, other embodiments may also be preferred, under the same or other circumstances. Furthermore, the recitation of one or more preferred embodiments does not imply that other embodiments are not useful and is not intended to exclude other embodiments from the scope of the disclosure.

In this application, terms such as “a,” “an,” and “the” are not intended to refer to only a singular entity but include the general class of which a specific example may be used for illustration. The terms “a,” “an,” and “the” are used interchangeably with the term “at least one.”

The phrases “at least one of” and “comprises at least one of” followed by a list refers to any one of the items in the list and any combination of two or more items in the list.

As used herein, the term “or” is generally employed in its usual sense including “and/or” unless the content clearly dictates otherwise.

The term “and/or” means one or all of the listed elements or a combination of any two or more of the listed elements.

As used herein in connection with a measured quantity, the term “about” refers to that variation in the measured quantity as would be expected by the skilled artisan making the measurement and exercising a level of care commensurate with the objective of the measurement and the precision of the measuring equipment used. Herein, “up to” a number (e.g., up to 50) includes the number (e.g., 50).

Also herein, the recitations of numerical ranges by endpoints include all numbers subsumed within that range as well as the endpoints (e.g., 1 to 5 includes 1, 1.5, 2, 2.75, 3, 3.80, 4, 5, etc.).

These and other embodiments of the present disclosure will be apparent from the detailed description below. In no event, however, should the above summaries be construed as limitations on the claimed subject matter, which subject matter is defined solely by the attached claims, as may be amended during prosecution.

### BRIEF DESCRIPTION OF DRAWINGS

Throughout the specification, reference is made to the appended drawings, where like reference numerals designate like elements, and wherein:

FIG. 1 is a schematic perspective view of one embodiment of an ear-wearable electronic device.

FIG. 2 is a schematic side view of the ear-wearable electronic device of FIG. 1.

FIG. 3 is a schematic cross-section view of the ear-wearable electronic device of FIG. 1 with an acoustic path and an electromechanical package of the device removed for clarity.

FIG. 4 is a schematic side cross-section view of a portion of the ear-wearable electronic device that illustrates the acoustic path of the device.

FIG. 5 is a schematic top cross-section view of a portion of the ear-wearable electronic device that illustrates the acoustic path of the device.

FIG. 6 is a schematic perspective view of the electromechanical package of the ear-wearable electronic device of FIG. 1.

FIG. 7 is a schematic top cross-section view of a portion of the ear-wearable electronic device that illustrates the acoustic path of the device with a microphone of the electromechanical package acoustically coupled to the acoustic path.

FIG. 8 is a schematic perspective view of a portion of a first housing of the enclosure of the ear-wearable electronic device of FIG. 1 with a mesh screen disposed over a first opening of the acoustic path.

FIG. 9 is a schematic side view of the ear-wearable electronic device disposed at least partially within a left ear of a wearer.

FIG. 10 is a schematic top cross-section view of a portion of the ear-wearable electronic device illustrating an orientation of the device as positioned in the left ear of the wearer as shown in FIG. 9.

FIG. 11 is a schematic side view of the ear-wearable electronic device disposed at least partially within a right ear of a wearer.

FIG. 12 is a schematic top cross-section view of a portion of the ear-wearable electronic device illustrating an orientation of the device as positioned in the right ear of the wearer as shown in FIG. 11.

FIG. 13 is a schematic side view of another embodiment of an ear-wearable electronic device.

FIG. 14 is a schematic perspective view of an acoustic boot of the ear-wearable electronic device of FIG. 13.

FIG. 15 is a schematic side view of the acoustic boot of FIG. 14.

FIG. 16 is a schematic top cross-section view of the acoustic boot of FIG. 14.

FIG. 17 is a schematic perspective view of an electromechanical package of the ear-wearable electronic device of FIG. 13 with a microphone of the package disposed at least partially within a microphone coupler of the acoustic boot of FIG. 14.

FIG. 18 is a block diagram of the ear-wearable electronic device of FIG. 1.

FIG. 19 is a flowchart of one technique of forming the ear-wearable electronic device of FIG. 1.

### DETAILED DESCRIPTION

In general, the present disclosure provides various embodiments of an ear-wearable electronic device that includes an acoustic path that extends between a first opening defined by an outer surface of an enclosure of the device and a second opening disposed within the enclosure. The second opening can be defined by a cavity of a microphone coupler disposed within the enclosure. The device can also include one or more traps connected to the acoustic path that are configured to collect debris such as ear wax that can enter the acoustic path from an external environment of the enclosure. In one or more embodiments, the one or more traps can be integral with the acoustic path.

Ear-wearable electronic devices such as hearing devices can include various features that may allow ingress of foreign debris (e.g., keratin, hair follicles, etc.) into an acoustic path of the device that is acoustically coupled to one or more components disposed within the device. Specifically, the acoustic path of the device may become a location where such debris accumulates. As a result, an internal geometry of the acoustic path may change due to the accumulated foreign material. In some cases, the acoustic path may become completely blocked or occluded, thereby restricting acoustic energy from reaching components within the device through the acoustic port or being directed from within the device through the acoustic port to an ear of a wearer.

One or more embodiments of an ear-wearable electronic device described herein can provide various advantages over currently available devices. For example, one or more embodiments of devices described herein can include an acoustic path with various features that are configured to collect at least a portion of debris that can enter the acoustic path and substantially preserve an internal acoustic path geometry. Such preserved internal acoustic path geometry can preserve sound quality performance of the device.

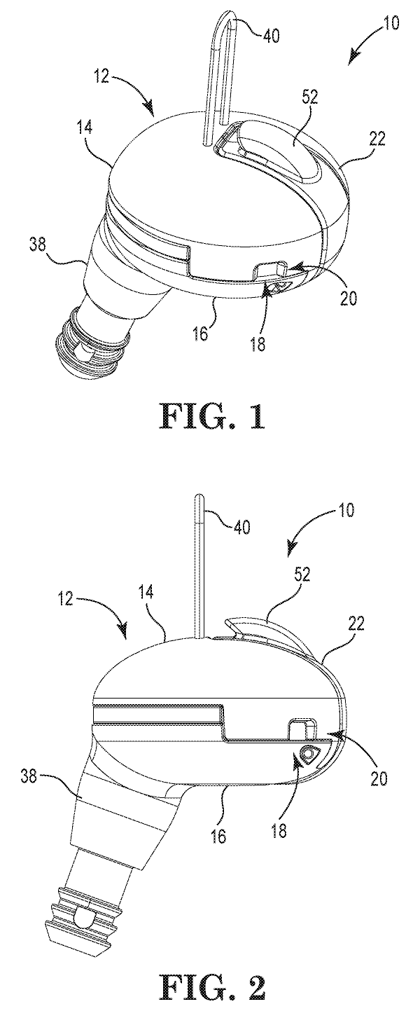

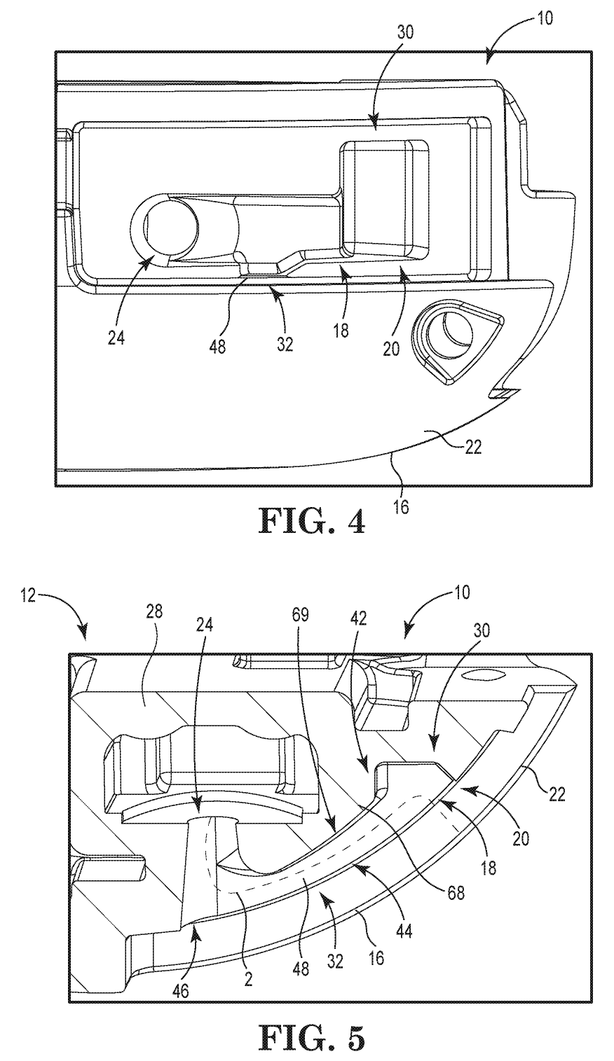

FIGS. 1 - 5 are various schematic views of an ear-wearable electronic device 10. The device 10 includes an enclosure 12 that includes a first housing 14 and a second housing 16, an acoustic path 18 (FIGS. 4 - 5) that extends along an axis 2 between a first opening 20 defined by an outer surface 22 of the enclosure and a second opening 24 defined by a surface of a cavity 26 of a microphone coupler 28 disposed within the enclosure, a first trap 30 connected to the acoustic path adjacent the first opening of the acoustic path, and a second trap 32 connected to the acoustic path so that the second trap is disposed between the second opening and the first trap along the axis. Each of the first trap 30 and second trap 32 is configured to collect debris.

The ear-wearable electronic device 10 can include any suitable device or devices. For example, the ear-wearable electronic device 10 can be a hearing assistance device. Any suitable hearing assistance device can be utilized, e.g., behind-the-ear (BTE), in-the-ear (ITE), in-the-canal (ITC), receiver-in-canal (RIC), completely-in-the-canal (CIC), or invisible-in-the-canal (IIC)-type hearing assistance devices. It is understood that BTE type hearing assistance devices can include devices that reside substantially behind the ear or over the ear. Such devices can include hearing aids with receivers associated with the electronics portion of the device or hearing aids of the type having receivers in the ear canal of the user, including but not limited to receiver-in-canal (RIC) or receiver-in-the-ear (RITE) designs. The present subject matter can also be used in hearing assistance devices generally, such as cochlear implant type hearing devices and deep insertion devices having a transducer, such as a receiver or microphone, whether custom fitted, standard, open fitted, or occlusive fitted. The present subject matter can additionally be used in consumer electronic wearable audio devices having various functionalities. It is understood that other devices not expressly stated herein can also be used with the present subject matter. Further, the device 10 can be included in an ear-wearable electronic device system that includes two or more devices. For example, the device 10 can be a first device disposed at least partially within an ear of a wearer, and a second ear-wearable electronic device can be disposed at least partially within a second ear of the wearer.

The device 10 can take any suitable shape and have any suitable design such that at least a portion of the enclosure fits at least partially within the wearer’s ear. The device 10 can include any suitable components such as one or more of a port, spout 38, earbud, antenna, handle 40, cover, or any other components suitable for assisting in the performance or function of the device. The device 10 can include any number of such components connected to or integral with the enclosure 12 (e.g., two antennas, three spouts, etc.). These components can be disposed in any suitable location or arrangement for assisting in the performance or function of the device 10.

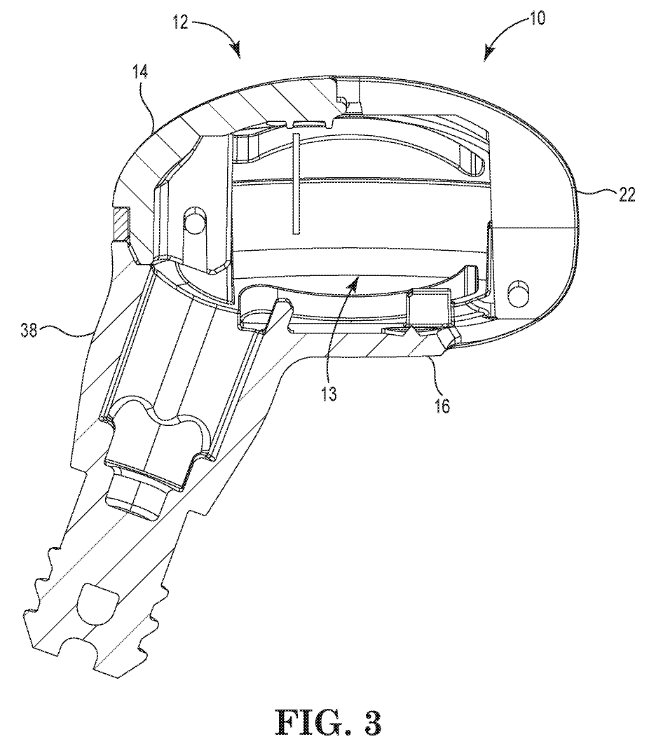

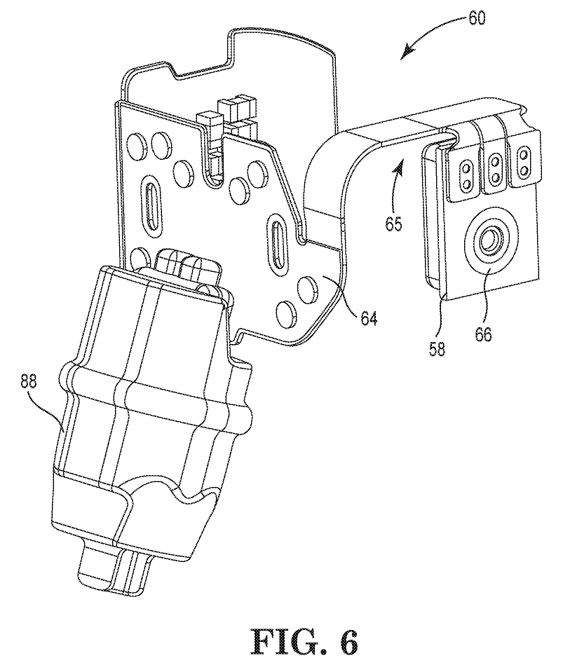

The enclosure 12 can take any suitable shape and have any suitable dimensions so that at least a portion of the enclosure fits within the ear of the wearer. The enclosure 12 can define an interior volume 13 as shown in FIG. 3, which is a schematic cross-section view of the device 10 with an electromechanical package 60 (FIG. 6) and the acoustic path 18 removed for clarity. Further, the enclosure 12 can include any suitable material, e.g., at least one of an inorganic material (e.g., metallic or ceramic material) or polymeric material (e.g., a thermoplastic or thermoset material).

The first housing 14 and the second housing 16 of the enclosure 12 can each take any suitable shape and have any suitable dimensions. Each of the first and second housings 14, 16 defines a portion of the enclosure 12. Further, the first and second housings 14, 16 can include any suitable materials, e.g., at least one of the materials described herein regarding the enclosure 12. The first and second housings 14, 16 can include the same materials. In one or more embodiments, the first housing 14 includes a material that is different from a material of the second housing 16. The first and second housings 14, 16 can be manufactured utilizing the same technique or different techniques.

The first housing 14 and the second housing 16 can be connected using any suitable technique to form the enclosure 12. Examples of suitable techniques can include at least one of mechanical fastening, friction fitting, welding, molding, or adhesively connecting. In one or more embodiments, the first housing 14 can be integral with the second housing 16, i.e., manufactured as a single component, using any suitable technique.

The device 10 further includes the acoustic path 18, which extends along the axis 2 between the first opening 20 and the second opening 24 disposed within the enclosure 12. Although depicted as including first and second openings, 20, 24, the acoustic path 18 can include any suitable number of openings. The axis 2 is defined as an axis that intersects a geometrical center of each cross-sectional plane along the acoustic path 18.

In general, the acoustic path 18 can take any suitable shape. For example, the acoustic path 18 can include one or more straight or curved portions. Further, for example, the acoustic path 18 can be a tortuous path that includes multiple changes in direction relative to an initial direction of the path at either the first opening 20 or the second opening 24 of the path. In one or more embodiments, the acoustic path 18 can be straight and not include any direction changes. In one or more embodiments, the acoustic path 18 can include any other suitable direction changes for assisting in the performance or function of the device 10.

The acoustic path 18 acoustically couples the first opening 20 and the second opening 24. As used herein, the term “acoustically coupled” means fluidically coupled or that any barrier disposed between two or more elements or components that are acoustically coupled is generally acoustically transparent for frequencies of interest, where acoustically transparent means that the element or component attenuates sound at a sound pressure level of no greater than 6 dB.

Further, the acoustic path 18 can take any suitable cross-sectional shape in a plane substantially orthogonal to the axis 2. In one or more embodiments, at least a portion of the acoustic path 18 includes a rectangular shape in the cross-sectional plane orthogonal to the axis 2 of the acoustic path. For example, as shown in FIG. 5, at least a middle or second portion 44 of the acoustic path 18 includes a rectangular shape in a cross-sectional plane that is substantially orthogonal to the axis 2. In one or more embodiments, at least a portion of the acoustic path 18 can take an elliptical shape in the cross-sectional plane orthogonal to the axis 2 of the acoustic path 18. The acoustic path 18 can take the same cross-sectional shape along the axis 2. In one or more embodiments, the cross-sectional shape of the acoustic path 18 can vary along the axis 2. Additional suitable cross-sectional shapes include, triangular, polygonal, or faceted shapes.

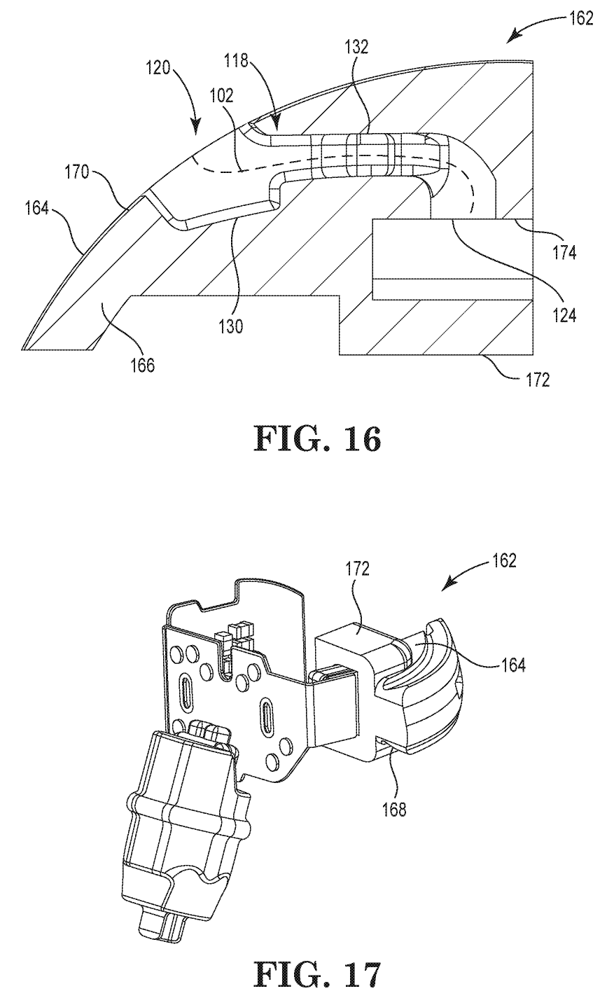

The acoustic path 18 can include a cross-sectional area in a cross-sectional plane orthogonal to the axis 2 that is the same along the axis. In one or more embodiments, the cross-sectional area of the acoustic path 18 can decrease along the axis 2 of the acoustic path in a direction from the first opening 20 to the second opening 24 as shown in FIG. 16. In one or more embodiments, the cross-sectional area of the acoustic path 18 can increase along the axis 2 of the acoustic path in a direction from the first opening 20 to the second opening 24.

The acoustic path 18 can be defined or formed by any suitable portion or portions of the enclosure 12. For example, as shown in FIGS. 1 - 5, the acoustic path 18 is defined by the first housing 14 and the second housing 16. Any suitable portion or portions of each of the first and second housings 14, 16 can define the acoustic path 18. The acoustic path 18 can be enclosed when the first housing 14 and the second housing 16 are connected, thereby providing an acoustic conduit that can allow acoustic waves to enter and/or exit the defined volume 13 of the enclosure 12. In one or more embodiments, the acoustic path 18 includes one or more walls 68 formed by at least one of the first housing 14 or the second housing 16.

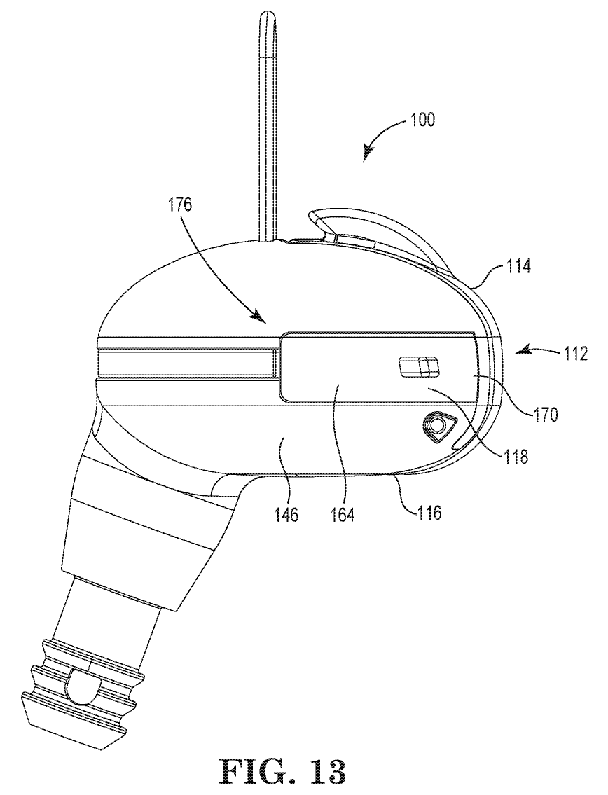

In one or more embodiments, the acoustic path 18 can be a separate element or component that is disposed at least partially within the enclosure 12 using any suitable technique. For example, FIGS. 15 - 17 are various schematic views of another embodiment of an ear-wearable electronic device 100. All design considerations and possibilities described herein regarding the ear-wearable electronic device 10 of FIGS. 1 - 12 apply equally to the ear-wearable electronic device 100 of FIGS. 13 - 17 unless stated otherwise. The device 100 can include any suitable ear-wearable electronic device, e.g., one or more embodiments of ear-wearable electronic devices described in co-filed U.S. Provisional Patent Application No. 63/725,600 (Atty Docket No. ST1088PRV), entitled EAR-WEARABLE ELECTRONIC DEVICE INCLUDING ACOUSTIC BOOT.

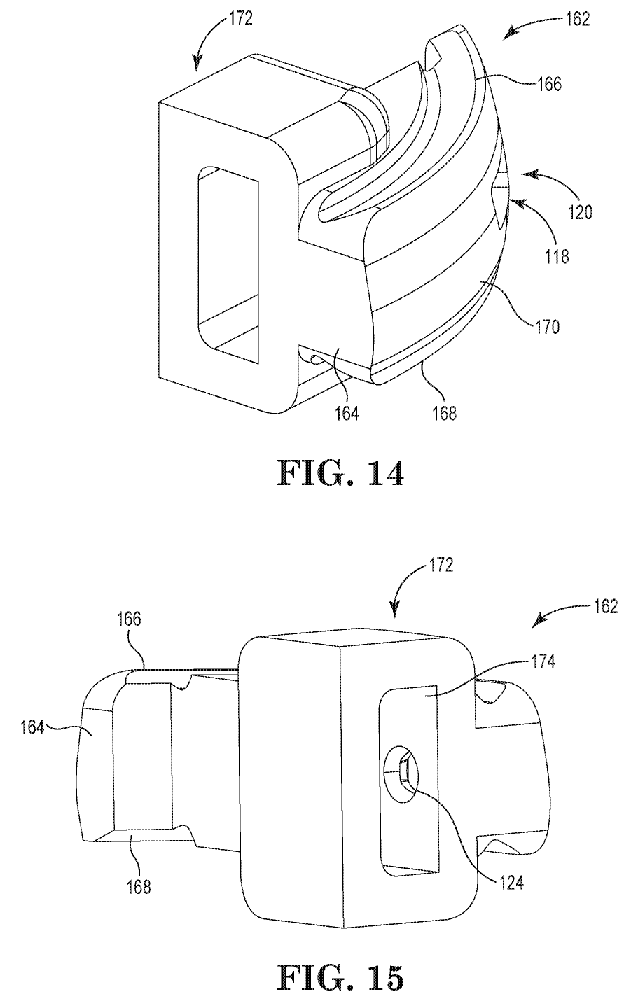

The device 100 includes an enclosures 112 that has a first housing 114, a second housing 116, and an acoustic boot 162 disposed between the first housing and the second housing. As shown in FIGS. 14 - 16, the acoustic boot 162 includes a body 164 having a first major surface 166, a second major surface 168, and an outer body surface 170 that extends between the first and second major surfaces and connects the first and second major surfaces. The acoustic boot 162 also includes a microphone coupler 172 connected to the body 164 and disposed within the enclosure 112 (FIG. 13). The acoustic boot 162 can also include an acoustic path 118 (FIG. 16) defined by the body 164, where the acoustic path extends between a first opening 120 defined by the outer body surface 170 and a second opening 124 disposed within the microphone coupler 172 and defined by a cavity 174 of the microphone coupler.

In one or more embodiments, the device 100 can include an enclosure opening 176 (FIG. 13) defined by the first housing 114 and the second housing 116. The acoustic boot 162 can be at least partially disposed within the enclosure opening 176 so that the outer body surface 170 of the acoustic boot and the surfaces of the first housing 14 and second housing 16 are flush to form an outer surface 146 of the enclosure 112.

The acoustic boot 162 is disposed between the first housing 114 and the second housing 116. As used herein, the term “between the first housing and the second housing” means that at least a substantial portion of the acoustic boot 162 is disposed within an interior volume (e.g., interior volume 13 of device 10) of the enclosure 112 formed by the first and second housings 114, 116. In one or more embodiments, the acoustic boot 162 is disposed entirely within this interior volume of the enclosure 112 with the exception of the outer body surface 170 of the acoustic boot.

The acoustic boot 162 can take any suitable shape and have any suitable dimensions. Further, the acoustic boot 162 can include any suitable material. Examples of suitable materials include conductive metals, non-conductive metals, polymers, ceramics, glass, composites, or any combination of two or more of such materials. Examples of polymer materials include thermoplastic elastomers, thermoplastic polyurethane, thermoplastic copolyester, thermoplastic polyamide, thermoset elastomers (e.g., silicone) or any combination of two or more of such materials. The acoustic boot 162 can be formed by any suitable manufacturing process. Examples of manufacturing processes include 3D printing, extruding, or injection molding, compression molding, casting, etc. The acoustic boot 162 can be a unitary component or two or more portions that are connected together using any suitable technique.

In one or more embodiments, at least one of the first housing 114 or second housing 116 can be connected to the acoustic boot 162. In one or more embodiments, the first major surface 166 of the body 164 is connected to the first housing 114 and the second major surface 168 of the body is connected to the second housing 116. In one or more embodiments, the first housing 114 is connected to the acoustic boot 162 and the second housing 116 using any suitable technique. In one or more embodiments, the first housing 114 is adhesively connected to at least one of the acoustic boot 162 or the second housing 116. In one or more embodiments, the second housing 116 is connected to the acoustic boot 162.

The acoustic boot body 164 further includes the acoustic path 118 (FIG. 16). The acoustic path 118 can include any suitable acoustic path described herein, e.g., acoustic path 18 of ear-wearable electronic device 10 of FIGS. 1 - 12. In one or more embodiments, the acoustic path 118 is defined by the body 164 of the acoustic boot 162. The acoustic path 118 extends between the first opening 120 defined by the outer body surface 170 of the body 164 and the second opening 124 that is disposed within the microphone coupler 172 and defined by the cavity 174 of the microphone coupler. The acoustic path 118 can extend along an axis 102 between the first opening 120 and the second opening 124.

The device 100 can include a first trap 130 connected to the acoustic path 118 adjacent the first opening 120 of the acoustic path, and a second trap 132 connected to the acoustic path so that the second trap is disposed between the second opening 124 and the first trap along the axis 102. Each of the first and second traps 130, 132 can include any suitable trap described herein, e.g., first and second traps 30, 32 of device 10 of FIGS. 1 - 12.

At least one of the acoustic path 118, first trap 130, or second trap 132 can be disposed in the acoustic boot 162 formed by the unitary body 164. In one or more embodiments, the acoustic path 118, first trap 130, and second trap are disposed in the acoustic boot 162. In one or more embodiments, at least one of the acoustic path 118, first trap 130, or second trap 132 is integral with the acoustic boot 162. In one or more embodiments, the acoustic path 118, first trap 130, and second trap 132 are integral with the acoustic boot 162.

Returning to FIGS. 1 - 12, the device 10 includes the first and second traps 30, 32 that are each connected to the acoustic path 18 using any suitable technique. Although depicted as including two traps 30, 32, the device 10 can include any suitable number of traps, e.g., the device can include a plurality of traps connected to the acoustic path 18. The first and second traps 30, 32 can each be connected to any suitable portion or portions of the acoustic path 18. In one or more embodiments, the first trap 30 can be connected to a first portion 42 of the acoustic path as shown in FIG. 5. Further, in one or more embodiments, the second trap 32 can be connected to the second or middle portion 44 of the acoustic path 18 such that the second trap is disposed between the first trap 30 and the second opening 24 of the acoustic path along the axis 2. In one or more embodiments, one or more traps can be disposed in a third portion 46 of the acoustic path 18.

Each of the first and second traps 30, 32 can be integral with the acoustic path 18. For example, the first trap 30can be disposed in a wall 68 of the acoustic path 18 as shown in FIG. 5. Further, for example, the second trap 32 can be disposed in a bottom wall 69 of the acoustic path 18. In one or more embodiments, at least one of the first or second traps 30, 32 can be manufactured separately and connected to the acoustic path 18 using any suitable technique.

Further, each of the first and second traps 30, 32 can take any suitable shape and have any suitable dimensions. Further, at least one of the first or second traps 30, 32 can include one or more ramped or faceted portions. For example, as illustrated in FIG. 4, the second trap 32 includes a ramped portion 48 that is configured to collect debris so that the debris does not substantially occlude the acoustic path 18.

Each of the traps 30, 32 can include any suitable features to collect foreign material such as adhesives, coatings, mechanical features, or any combination of two or more thereof.

The device 10 can also include one or more mesh screens 50 (FIG. 8) that can be configured to retain debris (e.g., earwax, keratin, hair follicles, etc.). The mesh screen 50 can include any suitable material. Further, the mesh screen 50 can be disposed in any suitable location over or at least partially within the acoustic path 18, e.g., adjacent at least one of the first opening 20 or the second opening 24 of the path. As shown in FIG. 8, the mesh screen 50 can be disposed over the first opening 20 of the acoustic path 18. In one or more embodiments, the mesh screen 50 can be disposed over the microphone inlet 66 of the microphone 58.

The device 10 can include any suitable electronic components or circuitry. For example, FIG. 6 is a schematic perspective view of the electromechanical package 60 of the device. The electromechanical package 60 can be disposed at least partially within the interior volume 13 of the enclosure 12. In one or more embodiments, the package 60 can be disposed entirely within the enclosure 12. The electromechanical package 60 can include any suitable components or circuitry. Examples of suitable components or circuitry include flexible circuit board assemblies (PCBA), batteries, microphones, cameras, receivers, radios, one or more sensors, such as a motion detector, a microphone, a heart rate sensor, or an electrophysiological sensor, or any circuitry or components suitable for assisting in the performance or function of hearing devices.

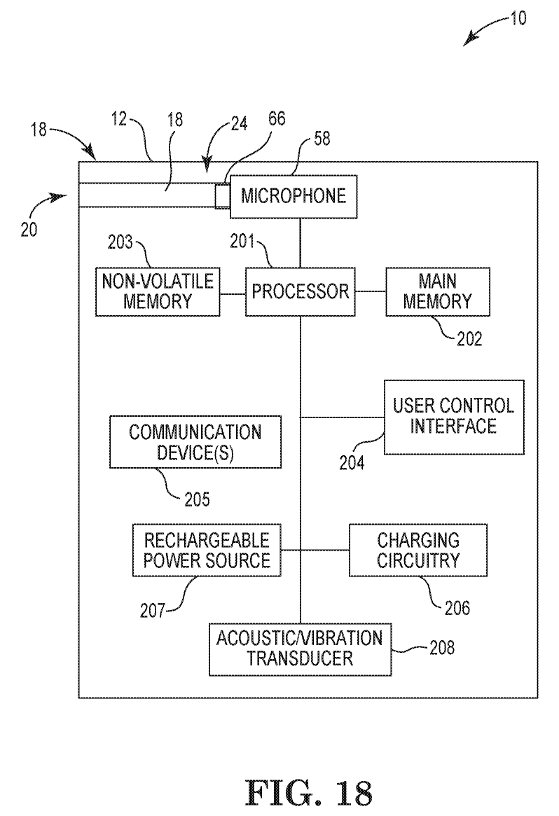

As shown in FIG. 6, the electromechanical package 60 includes a PCBA 64 and the microphone 58 disposed on or at least partially in the PCBA. The PCBA 64 can include any suitable layer or layers. As used herein the term “PCBA” refers to a laminated, flexible sandwich structure that can include conductive layers, insulating layers, and vias allowing for interconnections between layers. The PCBA 64 can support and/or be coupled to various electronic components (e.g., integrated circuits, processors, memories), electrical circuitry (passive and active electrical components), one or more sensors, and/or one or more transducers (e.g., the microphone 58, a receiver, etc.) as is further described herein in reference to FIG. 18.

The microphone 58 can include any suitable microphone or microphone array, e.g., a MEMS microphone, an electret condenser microphone, co-joined microphone sets, etc. The microphone 58 can be electrically connected to the PCBA 64 using any suitable technique, e.g., one or more of the techniques described in U.S. Patent Publication No. 2023/0336928 A1. The device 10 can include any suitable number of microphones.

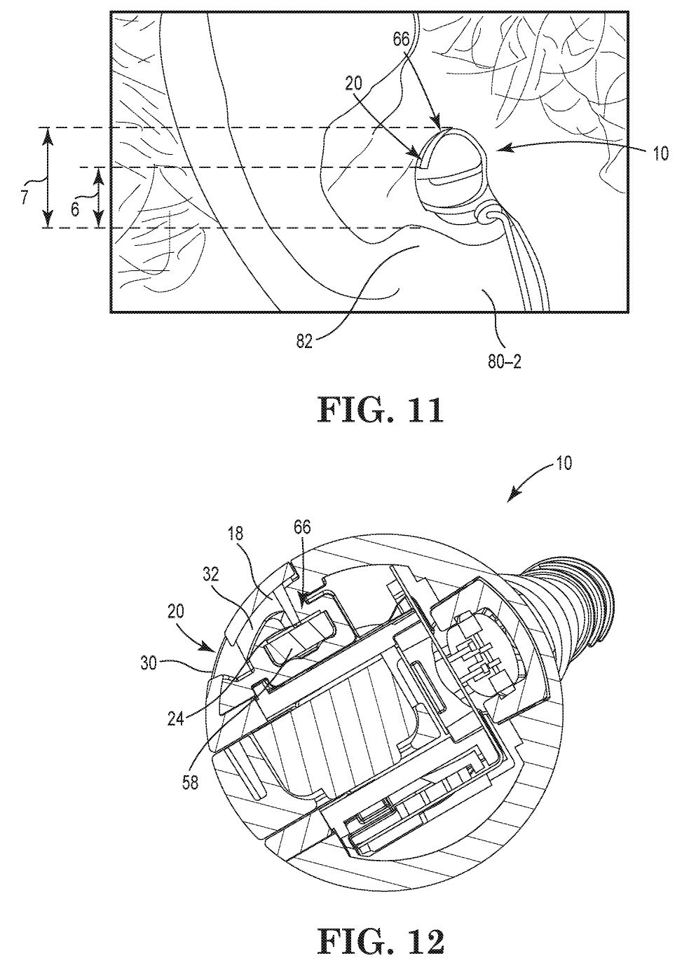

The microphone 58 can be configured to convert acoustic waves that enter the microphone through the acoustic path 18 and a microphone inlet 66 (FIG. 11) into one or more electric signals that are directed to a controller or processor (e.g., processor 201 of FIG. 18) of the electromechanical package 60 that is disposed within the enclosure 12 or remotely from the enclosure by a wired or wireless connection.

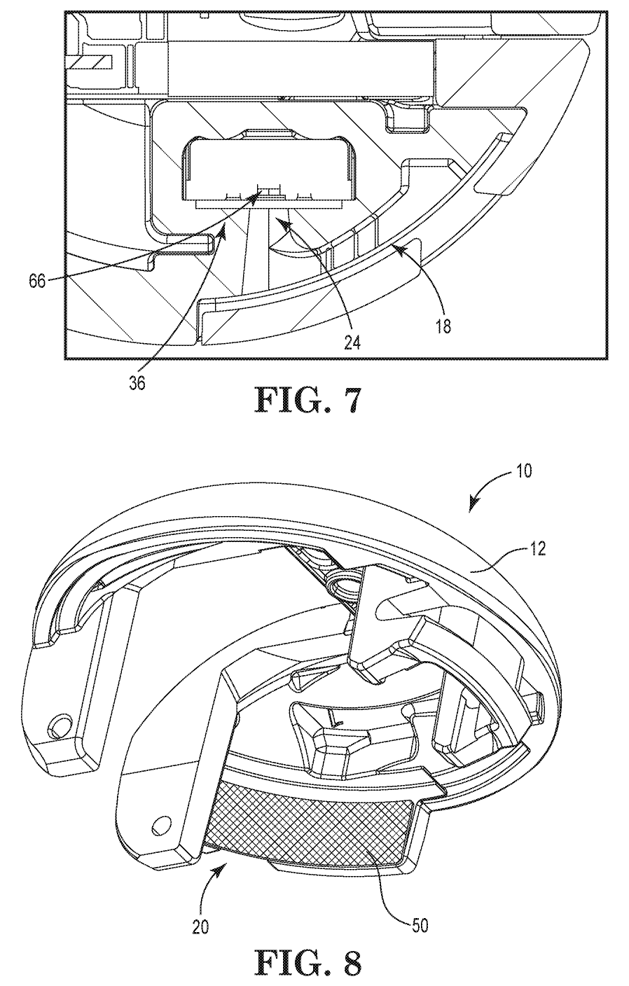

As shown in FIG. 7, which is a schematic cross-section view of a portion of the device 10, the microphone 58 can be disposed at least partially in the cavity 36 of the microphone coupler 28 defined by at least one of the first housing 14 or second housing 16. In one or more embodiments, the coupler 28 can be defined by a separate element or component that is connected to an inner surface of at least one of the first or second housing 14, 16. In one or more embodiments, the microphone 58 is disposed completely or entirely within the cavity 36. In one or more embodiments, the microphone 58 and at least the portion 65 of the PCBA 64 upon which the microphone is disposed can be disposed at least partially within the cavity 36. In this configuration, the microphone inlet 66 of the microphone 58 can be acoustically coupled to the acoustic path 18 via the second opening 24 of the path (FIG. 7). Any suitable technique can be utilized to acoustically couple the microphone 58 to the acoustic path 18.

At least one of the microphone 58 or the portion 65 of the PCBA 64 can be connected to the microphone coupler 28 using any suitable technique. In one or more embodiments, at least one of the microphone 58 or the portion 65 of the PCBA 64 can be friction fit within the cavity 36 of the microphone coupler 28. In one or more embodiments, the microphone 58 and the portion 65 of the PCBA can be adhered, mechanically fastened, or bonded to the microphone coupler 28.

The device 10 can include any additional elements or components. For example, the device 10 can include a handle 40 that is configured to relay signals to and from components or circuitry of the device and assist the wearer in grasping the device. The handle 40 can be disposed on any suitable portion or portions of the enclosure 12 or within the enclosure. Further, the handle 40 can take any suitable shape and have any suitable dimensions.

The device 10 can also include a battery cover 52 configured to allow access to a battery (not shown) within the device. The battery cover 52 can be disposed on or at least partially within any suitable portion or portions of the enclosure 12. Further, the battery cover 52 can take any suitable shape and have any suitable dimensions.

As shown in FIG. 1, the device 10 can also include a spout 38 that is configured to receive an earbud and be placed at least partially within the wearer’s ear canal. The spout 38 can be integral with the second housing 16 or manufactured separately and connected to the second housing using any suitable technique. In one or more embodiments, the spout 38 can form a portion of the enclosure. One or more electronic components or circuitry can be disposed within the spout. For example, a receiver 88 (FIG. 6) can be disposed at least partially within the spout 38 and connected to the electromechanical package 60.

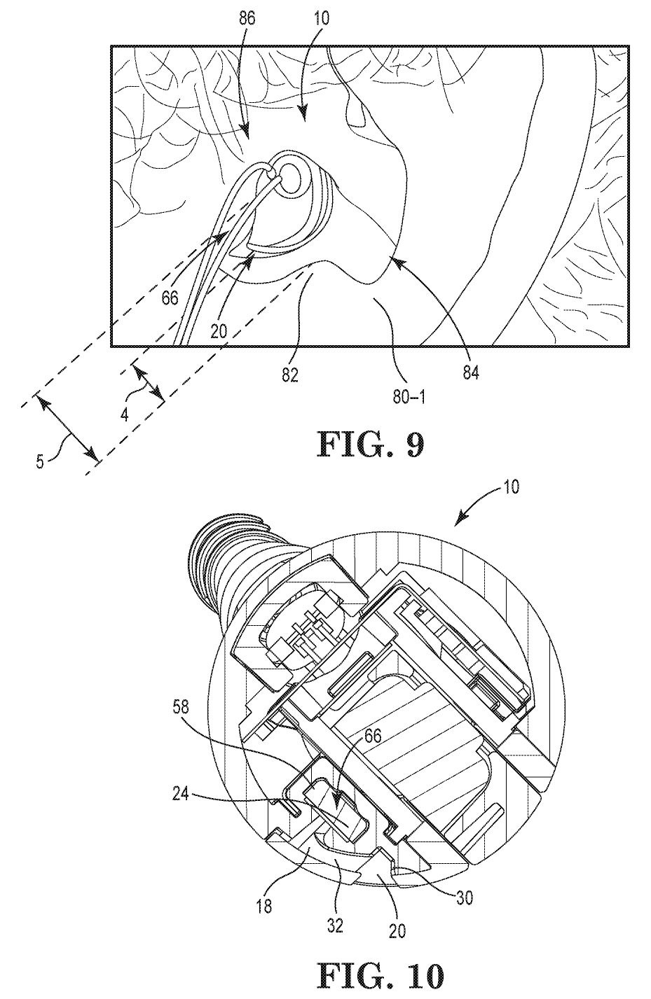

In general, the various embodiments of ear-wearable electronic devices described herein can be configured to be disposed in any suitable orientation when disposed at least partially within the ear of the wearer. For example, as shown in FIGS. 9 - 10, the device 10 is configured such that when the device is disposed at least partially within an ear 80 of the wearer, a distance 4 from the first opening 20 of the acoustic path 18 to an antitragus 82 of the ear is less than a distance 5 from the microphone inlet 66 of the microphone 58 to the antitragus when the second housing 14 of the device 10 is in contact with a concha 84 of the ear of the wearer and the spout 38 is disposed at least partially within an ear canal 86 of the wearer. FIG. 10 is a schematic cross-section view of the device 10 in the same orientation as is shown in FIG. 9 with the ear removed for clarity. While not wishing to be bound by any particular theory, the orientation of the microphone inlet 66 above the traps 30, 32 when the wearer is in an upright position can utilize gravity to assist in collecting debris in the traps so that the debris is less likely to reach the microphone inlet 66.

In one or more embodiments, the device 10 can be designed such that this positioning of the first opening 20 and the microphone inlet 66 remains the same regardless of which ear the device is disposed. As shown in FIGS. 9–10, the device 10 is oriented such that can be disposed in a left ear 80–1 of the wearer. FIGS. 11 - 12 are schematic views of the device 10 disposed in a right ear 80–2 of the wearer. The device 10 is configured such that when the device is disposed at least partially within the right ear 80–2 of the wearer, a distance 6 from the first opening 20 of the acoustic path 18 to the antitragus 82 of the ear is less than a distance 7 from the microphone inlet 66 of the microphone 58 to the antitragus when the second housing 14 of the device 10 is in contact with the concha 84 of the right ear of the wearer and the spout 38 is disposed at least partially within the ear canal 86 of the wearer. FIG. 12 is a schematic cross-section view of the device 10 in the same orientation as is shown in FIG. 11 with the ear removed for clarity.

The various embodiments of ear-wearable electronic devices described herein can include any suitable electronic components or circuitry. For example, FIG. 18 is a block diagram that illustrates various electronic components and circuitry of the device 10. The illustrated components and circuitry can be disposed on or connected to the electromechanical package 60 or disposed on or within the enclosure 12 separate from the package.

The device 10 includes a processor 201 operatively coupled to a main memory 202 and a non-volatile memory 203. The processor 201 can be implemented as one or more of a multi-core processor, a digital signal processor (DSP), a microprocessor, a programmable controller, a general-purpose computer, a special-purpose computer, a hardware controller, a software controller, a combined hardware and software device, such as a programmable logic controller, and a programmable logic device. The processor 201 can include or be operatively coupled to main memory 202. The processor 201 can include or be operatively coupled to non-volatile memory 203.

In one or more embodiments, the device 10 includes an audio processing facility operably coupled to, or incorporating, the processor 201. The audio processing facility includes audio signal processing circuitry (e.g., analog front-end, analog-to-digital converter, digital-to-analog converter, DSP, and various analog and digital filters), the microphone 58, and an acoustic/vibration transducer 208 (e.g., loudspeaker, receiver, bone conduction transducer, motor actuator). In one or more embodiments, the transducer 208 is one or more MEMS receivers. Each of the microphone 58 and transducer 208 can be disposed on or at least partially in the PCBA 64 disposed within the device 10. The acoustic transducer 208 can be configured to produce amplified sound inside the ear canal.

The microphone 58 can include one or more discrete microphones or a microphone array. Each of the microphones 58 can be situated at different locations of the device 10. It is understood that the term microphone used herein can refer to a single microphone or multiple microphones unless specified otherwise. The microphone 58 is operatively coupled to the processor 201 and is configured to direct a microphone signal to the processor, which in turn directs a receiver signal to the transducer 208 that is based at least in part on the microphone signal.

The device 10 also includes the acoustic path 18 that extends between the first opening 20 and the second opening 24. The acoustic path 18 is acoustically coupled to the inlet 66 of the microphone 58 via the second opening 24 of the acoustic path as shown in FIG. 7.

In one or more embodiments, the device 100 can also include a user control interface 204 operatively coupled to the processor 201. The user control interface 204 is configured to receive an input from the wearer of the device 10. The input from the wearer can be any type of user input, such as a touch input, a gesture input, or a voice input.

The device 10 can also include one or more communication devices 205. For example, the one or more communication devices 205 can include one or more radios coupled to one or more antenna arrangements that conform to an IEEE 802.13 (e.g., Wi-Fi®) or Bluetooth® (e.g., BLE, Bluetooth® 4.2, 5.0, 5.1, 5.2 or later) specification, for example. In addition, or alternatively, the device 10 can include a near-field magnetic induction (NFMI) sensor (e.g., an NFMI transceiver coupled to a magnetic antenna) for effecting short-range communications (e.g., ear-to-ear communications, ear-to-kiosk communications). The communications device 205 can also include wired communications, e.g., universal serial bus (USB) and the like. Further, the communication devices 205 can include a flexible antenna disposed on or at least partially within the PCBA disposed within the device 10.

The device 10 also includes a power source 207, which can be a conventional battery, a rechargeable battery (e.g., a lithium-ion battery), or a power source including a supercapacitor. In the embodiment shown in FIG. 18, the power source 207 includes a rechargeable power source that is operably coupled to power management circuitry for supplying power to various components of the device 10. The rechargeable power source 207 is coupled to charging circuity 206.

The device 10 can further include any other suitable electronic components or circuitry. Although not shown, the device 10 can include one or more inertial measurement units (IMUs) disposed within the device. In one or more embodiments, such IMUs can be disposed on or at least partially within the PCBA 64 that is disposed within the device.

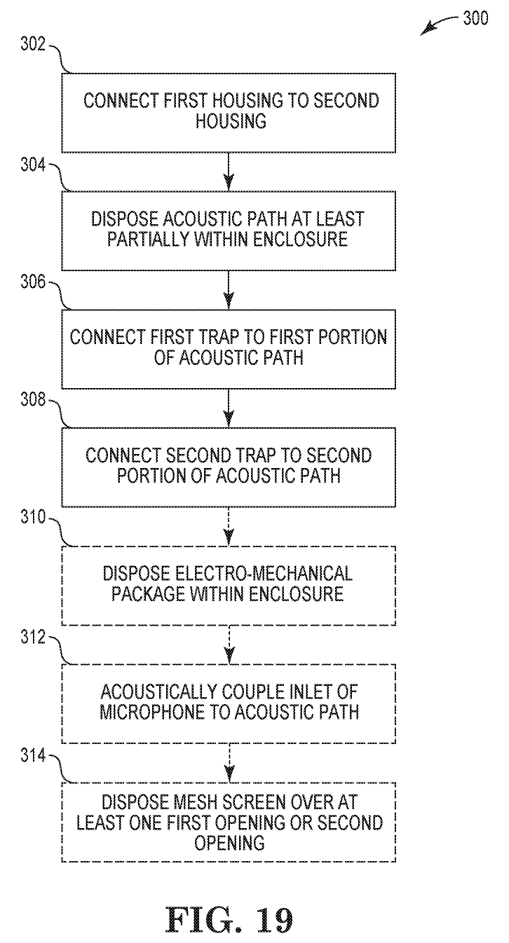

The various embodiments of ear-wearable electronic devices described herein can be manufactured using any suitable technique. For example, FIG. 19 is a flowchart of one embodiment of a technique 300 for manufacturing the ear-wearable electronic device 10. Although described in reference to ear-wearable electronic device 10 of,FIGS. 1 - 12 the technique 300 can be utilized to manufacture any suitable ear-wearable electronic device. At 302, the first housing 14 can be connected to the second housing 16 using any suitable technique. Further, the acoustic path 18 can be disposed at least partially within the enclosure 12 at 304 using any suitable technique. In one or more embodiments, at least a portion of at least one of the first housing 14 or second housing 16 can form the acoustic path 18. In one or more embodiments, the acoustic path 18 can be disposed by disposing the acoustic path in a unitary body 164 of an acoustic boot 162 of FIGS. 13 - 17, and the acoustic boot can be disposed at least partially within the enclosure 12. In one or more embodiments, the acoustic boot 162 can be disposed within the enclosure opening 176 defined by the first housing 114 and the second housing 116 as shown in FIG. 13.

At 306, the first trap 30 can be connected to a first portion 42 of the acoustic path 18 adjacent the first opening 20 of the acoustic path using any suitable technique. Further, at 308, the second trap 32 can be connected to the second portion 44 of the acoustic path 18 using any suitable technique. In one or more embodiments, at least one of the first or second traps 30, 32 can be integral with the acoustic path 18 such that the traps are disposed at least partially within the enclosure 12 at 304 along with the acoustic path.

At 310, the electromechanical package 60 can optionally be disposed within the enclosure 12 using any suitable technique. The microphone 58 can be disposed on the portion 65 of the PCBA 64 using any suitable technique prior to disposing the electromechanical package 60 within the enclosure 12 at 310. In one or more embodiments, the inlet 66 of the microphone 58 can optionally be acoustically coupled to the acoustic path 18 via the second opening 24 of the acoustic path at 312 using any suitable technique. Further, the mesh screen 50 can optionally be disposed over at least one of the first opening 20 or second opening 24 of the acoustic path 18 at 314 using any suitable technique.

Embodiments of the disclosure are defined in the claims; however, herein there is provided a non-exhaustive listing of non-limiting examples. Any one or more of the features of these examples may be combined with any one or more features of another example, embodiment, or aspect described herein.

Example Ex1. An ear-wearable electronic device including an enclosure having a first housing and a second housing, an acoustic path that extends along an axis between a first opening defined by an outer surface of the enclosure and a second opening defined by a surface of a cavity of a microphone coupler disposed within the enclosures, a first trap connected to the acoustic path adjacent the first opening of the acoustic path, and a second trap connected to the acoustic path so that the second trap is disposed between the second opening and the first trap along the axis. Each of the first trap and second trap is configured to collect debris.

Example Ex2. The device of Ex1, further including a plurality of traps connected to the acoustic path.

Example Ex3. The device of any one of Ex1–Ex2, further including an electromechanical package includes a flexible printed circuit board assembly (PCBA) disposed within the enclosure.

Example Ex4. The device of Ex3, where the electromechanical package further includes a microphone disposed on or at least partially in the PCBA.

Example Ex5. The device of Ex4, where the acoustic path is acoustically coupled to an inlet of the microphone via the second opening.

Example Ex6. The device of any one of Ex1–Ex5, where the acoustic path includes a rectangular shape in a cross-sectional plane orthogonal to the axis of the acoustic path.

Example Ex7. The device of any one of Ex1–Ex5, where the acoustic path includes an elliptical shape in a cross-sectional plane orthogonal to the axis of the acoustic path.

Example Ex8. The device of any one of Ex1–Ex7, where the acoustic path is defined by the first housing and the second housing.

Example Ex9. The device of any one of Ex1–Ex7, where the acoustic path, the first trap, and the second trap are disposed in an acoustic boot formed by a unitary body, where the acoustic boot is disposed between the first housing and the second housing.

Example Ex10. The device of Ex9, further including an enclosure opening defined by the first housing and the second housing.

Example Ex11. The device of Ex10, where the acoustic boot is at least partially disposed within the enclosure opening.

Example Ex12. The device of any one of Ex9–Ex11, where the first housing is connected to the acoustic boot and the second housing.

Example Ex13. The device of any one of Ex1–Ex12, where the first trap and the second trap are integral with the acoustic path.

Example Ex14. The device of any one of Ex1–Ex13, where the acoustic path includes a tortuous path.

Example Ex15. The device of any one of Ex1–Ex14, where the second trap includes a ramped portion.

Example Ex16. The device of Ex1, where the acoustic path includes a cross-sectional area that decreases along the axis of the acoustic path in a direction from the first opening to the second opening along the axis of the acoustic path.

Example Ex17. The device of any one of Ex1–Ex16, further including a mesh screen disposed over at least one of the first opening or the second opening.

Example Ex18. An ear-wearable electronic device, including an enclosure including a first housing, a second housing, and a spout extending from the second housing; and an electromechanical package. The package includes a flexible printed circuit board assembly (PCBA) disposed within the enclosure, and a microphone disposed on or at least partially in the PCBA and including a microphone inlet. The package further includes an acoustic path that extends along an axis between a first opening defined by an outer surface of the enclosure and a second opening defined by a surface of a cavity of a microphone coupler disposed within the enclosure, where the microphone inlet is acoustically coupled to the acoustic path via the second opening when the microphone is disposed at least partially within the cavity of the microphone coupler. The device further includes a trap connected to the acoustic path adjacent the first opening of the acoustic path, where the trap is configured to collect debris. A distance from the first opening of the acoustic path to an antitragus of an ear of a wearer is less than a distance from the microphone inlet to the antitragus when the second housing of the ear-wearable electronic device is in contact with a concha of the ear of the wearer and the spout is disposed at least partially within an ear canal of the wearer.

Example Ex19. The device of Ex18, where the device further includes a second trap connected to a middle portion of the acoustic path.

Example Ex20. The device of any one of Ex18–Ex19, where the acoustic path includes a rectangular shape in a cross-sectional plane orthogonal to the axis of the acoustic path.

Example Ex21. The device of any one of Ex18–Ex19, where the acoustic path includes an elliptical shape in a cross-sectional plane orthogonal to the axis of the acoustic path.

Example Ex22. The device of any one of Ex18–Ex21, where the acoustic path is defined by the first housing and the second housing.

Example Ex23. The device of any one of Ex18–Ex21, where the acoustic path is disposed in an acoustic boot formed by a unitary body, where the acoustic boot is disposed between the first housing and the second housing.

Example Ex24. The device of claim Ex23, further including an enclosure opening defined by the first housing and the second housing.

Example Ex25. The device of Ex24, where the acoustic boot is at least partially disposed within the enclosure opening.

Example Ex26. The device of any one of Ex23–Ex25, where the first housing is connected to the acoustic boot and the second housing.

Example Ex27. The device of any one of Ex18–Ex26, where the trap is integral with the acoustic path.

Example Ex28. The device of any one of Ex18–Ex27, where the acoustic path includes a tortuous path.

Example Ex29. The device of any one of Ex18–Ex28, where the acoustic path includes a constant cross-sectional area along the axis of the acoustic path.

Example Ex30. The device of any one of Ex18–Ex28, where the acoustic path includes a cross-sectional area that decreases along the axis of the acoustic path in a direction from the first opening to the second opening.

Example Ex31. The device of any one of Ex18–Ex30, further including a mesh screen disposed over at least one of the first opening or the second opening.

Example Ex32. A method of forming an ear-wearable electronic device, including connecting a first housing to a second housing to form an enclosure; disposing an acoustic path at least partially within the enclosure, where the acoustic path extends along an axis between a first opening defined by an outer surface of the enclosure and a second opening defined by a surface of a cavity of a microphone coupler disposed within the enclosure; connecting a first trap to a first portion of the acoustic path adjacent the first opening of the acoustic path; and connecting a second trap to a second portion of the acoustic path.

Example Ex33. The method of Ex32, further including connecting a plurality of traps to the acoustic path.

Example Ex34. The method of any one of Ex32–Ex33, where the first and second traps are integral with the acoustic path.

Example Ex35. The method of any one of Ex32–Ex34, further including disposing an electromechanical package within the enclosure, where the electromechanical package includes a flexible printed circuit board assembly (PCBA).

Example Ex36. The method of Ex35, further including disposing a microphone on or at least partially in the PCBA prior to disposing the electromechanical package within the enclosure.

Example Ex37. The method of Ex36, further including disposing the microphone at least partially within the cavity of the microphone coupler so that an inlet of the microphone is acoustically coupled to the acoustic path via the second opening of the acoustic path.

Example Ex38. The method of any one of claims Ex32– Ex37, where disposing the acoustic path includes: disposing the acoustic path in a unitary body of an acoustic boot; and disposing the acoustic boot at least partially within the enclosure.

Example Ex39. The method of Ex38, where disposing the acoustic boot includes disposing at least a portion of the acoustic boot within an enclosure opening defined by the first housing and the second housing.

Example Ex40. The method of any one of Ex32–Ex37, where the acoustic path is defined by the first housing and second housing.

Example Ex41. The method of any one of Ex32–Ex40, where the acoustic path further includes a tortuous path.

Example Ex42. The method of any one of Ex32–Ex41, further including disposing a mesh screen over at least one of the first opening or the second opening.

What is claimed is:

1. An ear-wearable electronic device comprising:
an enclosure comprising a first housing and a second housing;
an acoustic path that extends along an axis between a first opening defined by an outer surface of the enclosure and a second opening defined by a surface of a cavity of a microphone coupler disposed within the enclosure;
a first trap connected to the acoustic path adjacent the first opening of the acoustic path; and
a second trap connected to the acoustic path so that the second trap is disposed between the second opening and the first trap along the axis;
wherein each of the first trap and second trap is configured to collect debris.

2. The device of claim 1, further comprising an electromechanical package comprising a flexible printed circuit board assembly (PCBA) disposed within the enclosure and a microphone disposed on or at least partially in the PCBA.

3. The device of claim 1, wherein at least a portion of the acoustic path comprises a rectangular shape or an elliptical shape in a cross-sectional plane orthogonal to the axis of the acoustic path.

4. The device of claim 1, wherein the acoustic path is defined by the first housing and the second housing.

5. The device of claim 1, wherein the acoustic path, the first trap, and the second trap are disposed in an acoustic boot formed by a unitary body, wherein the acoustic boot is disposed between the first housing and the second housing.

6. The device of claim 5, further comprising an enclosure opening defined by the first housing and the second housing, wherein the acoustic boot is at least partially disposed within the enclosure opening.

7. The device of claim 1, wherein the first trap and the second trap are integral with the acoustic path.

8. The device of claim 1, wherein the acoustic path comprises a tortuous path.

9. The device of claim 1, wherein the second trap comprises a ramped portion.

10. The device of claim 1, wherein the acoustic path comprises a cross-sectional area that decreases along the axis of the acoustic path in a direction from the first opening to the second opening along the axis of the acoustic path.

11. An ear-wearable electronic device, comprising:
an enclosure comprising a first housing, a second housing, and a spout extending from the second housing;
an electromechanical package comprising:
a flexible printed circuit board assembly (PCBA) disposed within the enclosure; and
a microphone disposed on or at least partially in the PCBA and comprising a microphone inlet;
an acoustic path that extends along an axis between a first opening defined by an outer surface of the enclosure and a second opening defined by a surface of a cavity of a microphone coupler disposed within the enclosure, wherein the microphone inlet is acoustically coupled to the acoustic path via the second opening when the microphone is disposed at least partially within the cavity of the microphone coupler; and
a trap connected to the acoustic path adjacent the first opening of the acoustic path, wherein the trap is configured to collect debris;
wherein a distance from the first opening of the acoustic path to an antitragus of an ear of a wearer is less than a distance from the microphone inlet to the antitragus when the second housing of the ear-wearable electronic device is in contact with a concha of the ear of the wearer and the spout is disposed at least partially within an ear canal of the wearer.

12. The device of claim 11, wherein the device further comprises a second trap connected to a middle portion of the acoustic path.

13. The device of claim 11, wherein the acoustic path is defined by the first housing and the second housing.

14. The device of claim 11, wherein the acoustic path is disposed in an acoustic boot formed by a unitary body, wherein the acoustic boot is disposed between the first housing and the second housing.

15. The device of claim 11, wherein the trap is integral with the acoustic path.

16. The device of claim 11, wherein the acoustic path comprises a tortuous path.

17. The device of claim 11, wherein the acoustic path comprises a cross-sectional area that decreases along the axis of the acoustic path in a direction from the first opening to the second opening.

18. A method of forming an ear-wearable electronic device comprising:
connecting a first housing to a second housing to form an enclosure;
disposing an acoustic path at least partially within the enclosure, wherein the acoustic path extends along an axis between a first opening defined by an outer surface of the enclosure and a second opening defined by a surface of a cavity of a microphone coupler disposed within the enclosure;
connecting a first trap to a first portion of the acoustic path adjacent the first opening of the acoustic path; and
connecting a second trap to a second portion of the acoustic path.

19. The method of claim 18, further comprising disposing:
an electromechanical package within the enclosure, wherein the electromechanical package comprises a flexible printed circuit board assembly (PCBA); and
disposing a microphone on or at least partially in the PCBA prior to disposing the electromechanical package within the enclosure.

20. The method of claim 18, further comprising disposing a mesh screen over at least one of the first opening or the second opening.
